(19) United States
(12) Patent Application Publication
(10) Pub. No.: US 2005/0274696 A1
(43) Pub. Date: Dec. 15, 2005

(54) Single-acid compensating system

(75) Inventors: Chang Kuei Huang, Miao-Li (TW); Jung-Lung Huang, Miao-Li (TW); Chen-Hsien Ou, Miao-Li (TW); Sheng-Chou Gau, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/151,872

(22) Filed: Jun. 13, 2005

(30) Foreign Application Priority Data
Jun. 11, 2004 (TW) 93116830

(51) Int. Cl. B44C 1/22

(52) U.S. Cl. 216/84; 216/83; 438/745; 252/79.1; 156/345.11

(57) ABSTRACT

A single-acid compensating system (20) includes an etching unit (201), and a monitoring and compensating unit (202). The etching unit includes an acid-mixing tank (212). The monitoring and compensating unit includes a measuring element (213), a compensating calculator (214), and a single-acid compensating tank (215). The acid-mixing tank, the measuring element, the calculator, and the compensating tank are connected to cooperatively form a compensating loop. When the measuring element measures that the concentration of the single-acid is lower than a lower limit, it transmits this information to the calculator. After processing the information and performing a calculation, the calculator determines a certain quantity of the single-acid which should be compensated in the acid-mixing tank. All these actions are automated, and they ensure that the concentration of the single-acid is constantly maintained very close to the optimal value. Therefore, the single-acid compensating system conveniently allows the etching process to continue steadily.

### BACKGROUND

1. Field of the Invention

The present invention relates to an auxiliary system used in wet etching processes, and particularly to a single-acid compensating system used in a wet etching machine and a single-acid compensating method using the system.

2. General Background

Wet etching processes have the advantages of low cost, high productivity, high reliability, and high selectivity of photomasks and substrate material. Thus wet etching processes are widely used in processes for manufacturing thin film transistor liquid crystal displays. In a wet etching process, an etchant is used to etch substrates. The etchant is typically an acid mixture comprising several single-acids. As the etching process proceeds, the concentration of one or more of the single-acids progressively decreases, and this generally decreases the uniformity of etching. Therefore, it is very important to keep the concentration of the mixed acid at a constant value. That is, it is very important to determine when to appropriately compensate each single-acid.

Conventionally, compensation of each single-acid is based on the output of substrates and the processing time for each substrate. This method depends on practical experience, and cannot accurately determine when the single-acid is in need of compensation. As a result, the time interval between successive compensation steps is very short. The frequent need for more single-acid and an operator's labor increases the cost of production.

Referring to FIG. 4, a single-acid monitoring system 10 typically includes an etching chamber 111, an acid-mixing tank 112, a pump 1120, and a single-acid measuring device 113. The chamber 111 and the tank 112 are connected and cooperatively form a circulatory loop. The measuring device 113 is connected to the tank 112.

In operation, mixed acid in the tank 112 is conveyed into the chamber 111 through the pump 1120. The mixed acid is used in an etching process within the etching chamber 111. Spent liquor is conveyed back to the tank 112 from the chamber 111, and the mixed acid is continuously conveyed to the chamber 111 from the tank 112. The measuring device 113 monitors concentration changes of, say, a certain single-acid ‘A.’ When the concentration of the single-acid ‘A’ becomes lower than a preset lower limit, the etching process must be temporarily suspended, while an operator adds an amount of the single-acid A into the tank 112. In this way, an optimal concentration of the single-acid A is maintained.

What is needed is an automated single-acid compensating system.

### SUMMARY

In one embodiment, a single-acid compensating system includes an etching unit, and a monitoring and compensating unit. The etching unit includes an acid-mixing tank. The monitoring and compensating unit includes a measuring element, a compensating calculator, and a single-acid compensating tank. The acid-mixing tank, the measuring element, the compensating calculator, and the single-acid compensating tank are connected to cooperatively form a single-acid compensating loop.

When the measuring instrument measures that the concentration of the single-acid is lower than a lower limit, the measuring element transmits this information to the compensating calculator. After processing the information and performing a calculation, the compensating calculator determines a certain quantity of the single-acid which should be compensated in the acid-mixing tank from the compensating tanks. In this way, an optimal concentration value of the single-acid in the acid-mixing tank is maintained. All these actions are automated, and they ensure that the concentration of the single-acid is constantly maintained very close to the optimal value. Therefore, the single-acid compensating system conveniently allows the etching process to continue steadily.

Other advantages and novel features will become more apparent from the following detailed description when taken in conjunction with the accompanying drawings, in which:

### BRIEF DESCRIPTION OF THE DRAWINGS

FIG. 1 is a schematic diagram of a single-acid compensating system according to a preferred embodiment of the present invention, showing a flow of materials and information thereof;

FIG. 2 is an abbreviated graph of single-acid concentration versus time interval, showing data in respect of both the single-acid compensating system of FIG. 1 and a conventional single-acid monitoring system (see below);

FIG. 3 is an abbreviated graph of single-acid concentration versus time interval, showing data only in respect of the single-acid compensating system of FIG. 1, and in particular showing a relation between adjustment of an optimal concentration value of a single-acid and a compensating time interval; and

FIG. 4 is a schematic diagram of a conventional single-acid monitoring system, showing a flow of materials and information thereof.

### DETAILED DESCRIPTION OF PREFERRED EMBODIMENTS

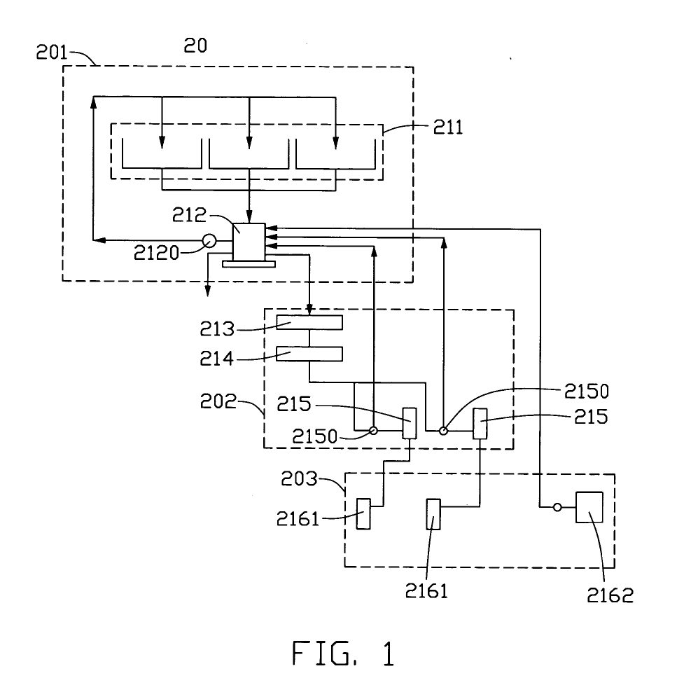

Referring to FIG. 1, a single-acid compensating system 20 according to a preferred embodiment of the present invention includes an etching unit 201, a monitoring and compensating unit 202, and a supplying unit 203. The etching unit 201 is connected with the monitoring and compensating unit 202, which in turn is connected with the supplying unit 203. The etching unit 201 includes an etching chamber 211, an acid-mixing tank 212, and a pump 2120. The monitoring and compensating unit 202 includes a single-acid measuring device 213, a single-acid compensating calculator 214, two single-acid compensating tanks 215, and two measuring pumps 2150. The supplying unit 203 includes two single-acid storages 2161 and a mixed acid storage 2162.

The measuring device 213 is connected to the acid-mixing tank 212. The compensating calculator 214 is connected to the compensating tanks 215 through the measuring pumps 2150 respectively. The compensating tanks 215 are connected to the acid-mixing tank 212. That is, the acid-mixing tank 212, the measuring device 213, the compensating calculator 214, and the compensating tanks 215 cooperatively form a single-acid compensating circulatory loop.

In operation, mixed acid in the acid-mixing tank 212 is conveyed in the etching chamber 211 through the pump 2120. The mixed acid is used in an etching process within the etching chamber 211. Spent liquor is conveyed back to the acid-mixing tank 212 from the etching chamber 211, and the mixed acid is continuously pumped into the etching chamber 211 from the acid-mixing tank 212.

The measuring device 213 can be a titration device or a spectrophotometer. In a typical application, the measuring device 213 monitors concentration changes of a certain single-acid. The measuring device 213 transmits concentration changes of the single-acid to the compensating calculator 214. The compensating calculator 214 controls the two measuring pumps 2150, so as to determine the quantity of single-acid which is compensated in the acid-mixing tank 212 from the compensating tanks 215.

When the measuring device 213 obtains a measurement of a concentration of the single-acid that is lower than a preset lower limit, the measuring device 213 transmits this information to the compensating calculator 214. After processing the information and performing a calculation, the compensating calculator 214 controls the measuring pumps 2150 to compensate a certain quantity of the single-acid in the acid-mixing tank 212 from the compensating tanks 215. In this way, an optimal concentration value of the single-acid in the acid-mixing tank 212 is maintained. The single-acid storages 2161 are connected to the compensating tanks 215 respectively, and supply single-acid for the compensating tanks 215. The mixed acid storage 2162 is connected to the acid-mixing tank 212, and directly supplies mixed acid for the acid-mixing tank 212.

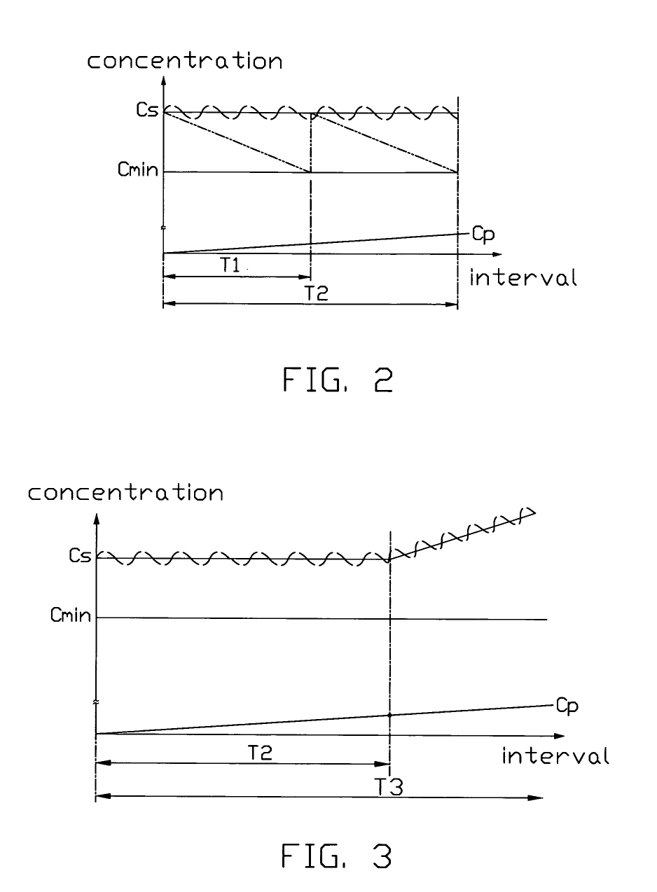

FIG. 2 shows a relation between concentration changes of the single-acid in the acid-mixing tank 212 and compensating time intervals. Cs is an optimal concentration value of the single-acid. Cmin is a lower limit concentration value of the single-acid. The line Cp represents a byproduct concentration. In the conventional single-acid monitoring system 10 (shown in FIG. 4), the compensating step is performed when the concentration of the single-acid is very close to Cmin, resulting in a short compensating time interval T1. In the preferred embodiment, the compensating step is automatically performed at fixed time intervals, so that the concentration of the single-acid is always close to the optimal value. Accordingly, compensating the single-acid depends primarily on Cp. It is only when Cp becomes large enough to affect the etching reaction that a compensating step is needed. Because the amount of byproduct is generally far less than the amount of mixed acid, a compensating time interval T2 of the preferred embodiment is much longer.

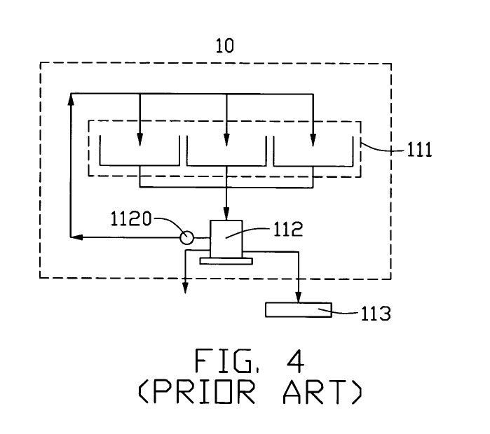

Also referring to FIG. 3, this shows a relation between adjustment of the optimal concentration value of the single-acid and compensating time interval. When Cp is enough large to affect the etching reaction, the optimal concentration Cs can be adjusted to an appropriate value, so that the etching process can continue steadily.

According to the above-described embodiments, when the measuring device 213 measures that the concentration of the single-acid is lower than the lower limit, the measuring device 213 transmits this information to the compensating calculator 214. After processing the information and performing a calculation, the compensating calculator 214 controls the measuring pumps 2150 to compensating a certain quantity of the single-acid in the acid-mixing tank 212 from the compensating tanks 215, so as to maintain an optimal concentration value of the single-acid. All these actions are automated, and they ensure that the concentration of the single-acid is constantly maintained very close to the optimal value. Therefore, the single-acid compensating system 20 conveniently allows the etching process to continue steadily.

It is to be further understood that even though numerous characteristics and advantages of the embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A single-acid compensating system, comprising:
an etching unit comprising an acid-mixing tank; and
a monitoring and compensating unit comprising a measuring element, a compensating calculator, and a single-acid compensating tank;
wherein the acid-mixing tank, the measuring element, the compensating calculator and the single-acid compensating tank are connected to cooperatively form a single-acid compensating loop.

2. The single-acid compensating system as claimed in claim 1, further comprising a supplying unit which supplies mixed acid for the acid-mixing tank and supplies single-acid for the single-acid compensating tank.

3. The single-acid compensating system as claimed in claim 2, wherein the supplying unit comprises a single-acid storage connected to the single-acid compensating tank, and an acid-mixing storage connected to the acid-mixing tank.

4. The single-acid compensating system as claimed in claim 1, wherein the monitoring and compensating unit further comprises a measuring pump, which is connected to the compensating calculator.

5. The single-acid compensating system as claimed in claim 1, wherein the etching unit further comprises an etching chamber and a pump, the pump being for transferring mixed acid from the acid-mixing tank to the etching chamber.

6. The single-acid compensating system as claimed in claim 1, wherein the measuring element comprises a titration device.

7. The single-acid compensating system as claimed in claim 1, wherein the measuring element comprises a spectrophotometer.

8. A single-acid compensating method, comprising:
(a) monitoring concentration changes of a body of single-acid;
(b) transforming monitored concentration changes into data signals;
(c) calculating a needed compensation of single-acid to the body of single-acid, based on the data signals, and sending corresponding control instructions; and
(d) controlling a quantity of compensating single-acid based on the control instructions.

9. The single-acid compensating method as claimed in claim 8, wherein a titration process is used in step (a).

10. The single-acid compensating method as claimed in claim 8, wherein spectrophotometry is used in step (a).

11. A single-acid compensating method, comprising:
(a) monitoring concentration changes of a body of single-acid;
(b) calculating a needed compensation of single-acid to the body of single-acid,
(c) sending corresponding control instructions; and
(d) controlling a quantity of compensating single-acid based on the control instructions; wherein
the compensating step is automatically performed at fixed time intervals so that concentration of the single acid is always close to the optimal value.
